(19) United States
(12) Patent Application Publication
(10) Pub. No.: US 2009/0044044 A1
(43) Pub. Date: Feb. 12, 2009

(54) DEVICE AND METHOD FOR CORRECTING ERRORS IN A SYSTEM HAVING AT LEAST TWO EXECUTION UNITS HAVING REGISTERS

(76) Inventors: Werner Harter, Illingen (DE); Eberhard Boehl, Reutlingen (DE); Thomas Lindenkreuz, Reutlingen (DE); Thomas Kottke, Ehningen (DE); Peter Tummeltshammer, Wien (AT)

Correspondence Address: KENYON & KENYON LLP, ONE BROADWAY, NEW YORK, NY, 10004, US

(21) Appl. No.: 12/094,229

(22) PCT Filed: Oct. 18, 2006
(86) PCT No.: PCT/EP06/67558

§ 371 Date: Aug. 26, 2008

(30) Foreign Application Priority Data
Nov. 18, 2005 (DE) 10 2005 055 067.3

(51) Int. Cl. G06F 11/14

(52) U.S. Cl. 714/6; 714/E11.054

(57) ABSTRACT

A device for correcting errors in a system having at least two execution units having registers is presented, the registers being designed for recording data. The device has comparison device(s) that are set up such that through a comparison of data that are provided for storage in the registers, a deviation and thus an error may be ascertained. Furthermore, at least one shadow register that is set up such that data concerning the data of the registers may be stored therein, and device(s) are provided for restoring error-free data in at least one register on the basis of the data in the at least one shadow register when an error is detected. This device may be used to improve the safety of a multicore processor.

### FIELD OF THE INVENTION

The present invention relates to a device and a method for correcting errors in a system or processor having at least two execution units or CPUs having registers as well as a corresponding processor.

### BACKGROUND INFORMATION

Due to the fact that semiconductor structures are becoming smaller and smaller, an increase in transient, that is, temporary, processor errors is expected, which are caused e.g. by cosmic radiation. Even today transient errors are already occurring, which are caused by electromagnetic radiation or induction of interferences into the supply lines of the processors.

In certain conventional arrangements, errors in a processor are detected by additional monitoring devices or by a redundant processor or by using a dual-core (double-core) processor.

Such a dual-core processor or such a processor system is made up of two execution units, in particular two CPUs (master and checker), which process the same program in parallel or in a time-delayed manner. The two CPUs (central processing unit) may operate in a clock-synchronized manner, that is, in parallel (in a lockstep mode or common mode) or in a manner that is time-delayed by a few clock cycles. Both CPUs receive the same input data and process the same program, although the outputs of the dual core are driven exclusively by the master. In each clock cycle, the outputs of the master are compared to the outputs of the checker and are thus verified. If the output values of the two CPUs do not agree, then this means that at least one of the two CPUs is in a faulty state.

In an exemplary architecture for a dual-core processor, a comparator compares for this purpose the outputs (instruction address, data out, control signals) of both cores (all comparisons occurring in parallel):
a: instruction address (Without a check of the instruction address, the master could address the wrong instruction without this being noticed, which would then be processed in both processors without being detected.)
b: data out
c: data address
d: control signals such as write enable or read enable
   The signals from b-d serve to activate the data memory or external modules.

A possible error is signaled externally and normally results in a shutdown of the affected control unit. With the expected increase in transient errors, this sequence would result in a more frequent shutdown of control units. Since in the case of transient errors there is no damage, in terms of hardware, to the computers it would be helpful to make the computer available again to the application as quickly as possible without the system shutting down or a restart having to be performed.

Methods for correcting transient errors while avoiding a complete restart of the processor are rarely found for processors working in a master/checker operation.

The publication by Jiri Gaisler, “Concurrent error-detection and modular fault-tolerance in a 32-bit processing core for embedded space flight applications,” from the Twenty-Fourth International Symposium on Fault-Tolerant Computing, pages 128-130, June 1994, shows a processor having integrated error detection and recovery mechanisms (for example, parity checking and automatic instruction repetition), which is capable of working in master/checker operation. The internal error detection mechanisms in the master or in the checker always trigger a recovery operation only locally in one processor. As a result, the two processors lose their synchronicity with respect to each other and it is no longer possible to compare the outputs. The only option for synchronizing the two processors again is to restart both processors during a non-critical phase of the mission.

Furthermore, the document by Yuval Tamir and Marc Tremblay entitled, “High-performance fault-tolerant vlsi systems using micro rollback” in IEEE Transactions on Computers, volume 39, pages 548-554, 1990, shows a method called “micro rollback”, by which the complete state of any VLSI system can be rolled back by a certain number of clock cycles. For this purpose, all registers and the register file as a whole are expanded by an additional FIFO buffer. According to this method, new values are not written directly into the register itself, but rather are first stored in the buffer and are transferred to the register only after having been checked. To roll back the entire processor state, the contents of all FIFO buffers are marked as invalid. If it is to be possible to roll back the system by up to k clock cycles, then k buffers are needed for each register.

These processors presented in certain conventional arrangements thus have the defect that they lose their synchronicity as a result of the recovery operations since recovery is always performed only locally in one processor. The basic aspect of the described method (micro rollback) is to extend each component of a system independently to include rollback capability so as to be able to roll back the entire system state in a consistent manner in the case of an error. The architecture-specific interconnection of the individual components (register, register file, . . . ) does not have to be considered for this purpose since indeed through rollback the entire system state is always rolled back consistently. The disadvantage of this method is a large hardware overhead, which grows in proportion to the size of the system (e.g., the number of pipeline stages in the processor).

A method and a device for correcting errors in a processor having two execution units and a corresponding processor are described in German Patent Application No. 102004058288.2, registers being provided in which instructions and/or associated information may be stored, the instructions being processed redundantly in both execution units and comparison means, such as, for example, a comparator being included, which are designed in such a way that by comparing the instructions and/or the associated information a deviation and thus an error is detected, a division of the registers of the processor into first registers and second registers being specified, the first registers being configured in such a way that a specifiable state of the processor and contents of the second registers are derivable from them, buffers being included as means for rolling back, which are designed in such a way that at least one instruction and/or the information in the first registers is rolled back and is executed anew and/or restored.

The measures proposed until now usually have the problem that significant changes to the processor structure are necessary, and therefore traditional processors cannot be used.

This presents the problem of correcting in particular transient errors without a system or processor restart while at the same time avoiding large hardware expenditure.

### SUMMARY

Thus, in accordance with example embodiments of the present invention, a method and a device as well as a corresponding processor are provided.

A shadow register is an additional register (copy, redundant register) to which the same data are always written as are written to the original register. In the event of errors in the original register, a switch is made to the shadow register or the data from the shadow register are transferred to the original register. It is practical, but not necessary, to divide the set of all registers of a CPU into two subsets: “essential registers” and “derivable registers.” The essential registers are configured such that the contents of derivable registers may be derived from them. An advantage of example embodiments of the present invention is that no substantial modification to the processors is necessary. It is sufficient to lead a few lines outside. Thus, the design approach according to example embodiments of the present invention may be implemented without requiring the development and manufacturing of new processors or systems. This results in a significant reduction of costs and time. In addition, the design approach according to example embodiments of the present invention is application-independent, that is, software-independent. In particular, it is not necessary to define any rollback points. Error correction is performed at the hardware level, which means that no software adjustment is required. Additionally, a recovery may be accelerated through the design approach according to example embodiments of the present invention. In contrast to task repetitions and resets, as are customary in certain conventional systems, that usually require several thousand or several million clock cycles, the design approach according to example embodiments of the present invention, requires only a few hundred clock cycles. This time is determined primarily by the size of the shadow register and the latency of the write accesses to the data memory of the execution units.

In the case of an error, the content of the shadow registers is read into the internal registers by the execution units, whereby a consistent processor state is established. In this context, the registers of all execution units may be filled from the shadow registers, but it is also possible to fill the registers of one execution unit from the shadow registers, and to fill the registers of the remaining execution units from the registers of the first CPU, etc. The device according to example embodiments of the present invention may be both an integrated component of the associated system, that is, for example, be designed as integrated in a dual-core processor, and designed as a separate structural component that is added to a system. Example embodiments of present invention may advantageously be used for control devices in a motor vehicle; however, it is not restricted to this type of use.

The following specification of the exemplary embodiments of the design approach according to the present invention refers to both the method and the device (recovery method and recovery device) unless it explicitly states otherwise.

Shadow registers for a processor or program status word (PSW), a register file, and/or an instruction address are advantageously provided in example embodiments of the present invention. A register file or a register bank or a register area is a grouping of registers. Expediently, enough shadow registers are provided to mirror the (essential) registers of an execution unit. Contents of the registers of the at least two execution units or, in general, data relating to the contents or data of the registers are written to the shadow registers. Thus, an error-free state of the execution units, in particular the immediately preceding error-free state, may be restored from the content of the shadow registers. In an example embodiment, data for the register file and the PSW provided for the at least two execution units are written to the at least one shadow register. The write process takes place in particular after a comparison of these data, and only in the case that no deviation, that is, no error has been detected. Through a comparison of the registers belonging to the execution units before writing to the shadow registers, it is possible to ensure that error-free data are written to the shadow registers. The data for the shadow registers may be obtained in particular by conducting out the relevant signals, for example, of the write-back bus, from the execution units. For this purpose, only minor modifications to the construction or hardware are required.

In an exemplary embodiment of the design approach according to the present invention, at least one shadow register is inserted in the memory area of at least one execution unit. In this manner, the shadow register may be read out quickly and easily by the at least one execution unit.

In the method according to example embodiments of the present invention, instructions from an instruction memory of the system having at least two execution units having registers are advantageously executed, address and write signals for the at least one shadow register being obtained thereby. In the process, preferably an instruction decoder that may be provided for the design approach according to example embodiments of the present invention decodes instructions from the instruction memory and generates the address and write signal for the at least one shadow register. It is also possible to do without an instruction decoder designed in this manner if this information, that is, the address and write signals, is conducted out of the at least two execution units, compared to each other, and used to activate of the at least one shadow register.

It may be provided to assign to the at least one shadow register a parity for ascertaining the correctness of the data in the shadow register. Thus it is possible to ensure in a simple manner that no erroneous data are contained in the shadow register. However, this is not necessary if one ensures through software that the register file and thus also the shadow register file are completely rewritten regularly, since existing errors in the shadow register file are thus overwritten. Before transferring the shadow register data to at least one of the execution units, it is possible to check the correctness by using the provided parity. If the data in the shadow register are no longer correct, it may be expedient to restart the system. Since the shadow register is accessed, via read access, only in the event of an error (here error refers not to errors in the shadow register, but rather to errors in the CPUs), a complete rewriting of the shadow registers is also possible.

In an example embodiment of the design approach according to the present invention, the data concerning the data of the registers are the, in particular error-free, data of the registers themselves, the error-free data being restored in at least one register by transferring the data from the shadow register to the at least one register. In this case, a shadow register contains the data of a register of an execution unit in the last error-free state, whereby in the event of an error the absence of errors may be restored by exchanging or transferring these data.

It may be provided that the error-free data concerning the data of the registers are check sums. In this context, it may in particular be a parity, CRC, etc. In this case, the data memory requirement of the shadow register is advantageously smaller than the size of a register of at least one execution unit. In this manner, memory space within the shadow register may be saved or the memory of the shadow register may be given smaller dimensions. To restore error-free data in a register of at least one execution unit, complete data must first be restored from the check sums, as is conventional. If only parities are stored in the shadow registers, at least two CPUs are to be provided. In the event of an error, the parities of the registers of both CPUs are compared to the shadow parities. Through this three-fold comparison, it is possible to ascertain which CPU is erroneous and to replace its erroneous register contents with the register contents of the functioning CPU.

According to an advantageous design of the method according to example embodiments of the present invention, data from at least two registers and at least one shadow register are compared and the data that conform for the most part are determined to be error-free. This method may be called a voting or majority method. In the process, the data from at least three registers are compared (at least two registers of the execution units and one shadow register), those data being determined as error-free which agree for the most part. This method may be advantageously used in particular if in order to increase the processing speed the at least one shadow register is already being written to before the correctness of the registers of the execution units has been checked.

It should be mentioned that in the case of an error instead of rewriting the data to the registers of the execution units, it is also possible to insert the shadow register or to perform a different kind of switchover.

A processor according to example embodiments of the present invention has at least two execution units having registers and at least one device according to example embodiments of the present invention. In this manner, the operation of one processor having at least two execution units having registers, in particular a dual-core processor, may be improved since transient errors may be corrected simply and quickly.

In an example embodiment, the processor has switchover device for switching over between a safety mode and a performance mode, the at least two execution units processing the same program in the safety mode and processing different programs in the performance mode. Of course, this refers in particular also to different parts of a program (parallel processing, multi-threading, symmetrical multiprocessor system SMP, etc.) The at least two execution units may in this context work in both modes at a clock pulse offset or clock-synchronously, as is described multiple times in this application. A combination of recovery mechanism and reconfiguration mechanism is essential. This allows the use of both methods and creates more room to maneuver between the safety and performance of the system used. For switching over between the modes, a mode-switch module may be provided that provides a mode signal. The core-mode signal must be relayed to the recovery device since the use of recovery is possible only in the safety mode. For example, in the automobile, different tasks are processed by computers. There are comfort functions (for example, climate control) and safety functions having safety requirements of varying levels (cf. engine control unit and electronic stability program). If these different applications are executed on a central control device, the program code may be subdivided into three classes:
program code for which permanent and transient errors must be discovered online (for example, ESP or x-by-wire applications),
program code for which the hardware used must be tested at regular intervals for permanent errors (for example, engine control unit, sunroof control),
program code that is not safety-related (for example, climate control).

It is thus advantageous to extend a processor according to example embodiments of the present invention to include the option of switching over between the two modes, safety and performance. In the safety mode, both processors process the same program code, also at a clock pulse offset, and in the performance mode they process different tasks. For applications that must be processed on tested hardware, this may happen alternately in the safety and performance mode. In this context, the hardware is tested by the redundancy of the two processors in the safety mode and the software thus runs on tested hardware in the performance mode. The distribution, that is, how often the software must be processed in which mode, depends on the required error discovery time, that is, the maximum time that an error may have an effect without the application potentially causing damage.

In an advantageous refinement of the processor according to example embodiments of the present invention, device(s) for emptying (flushing) a cache memory are provided. In this manner it is possible to easily prevent remaining data from the performance mode from being transferred to the recovery device.

It is possible to provide at least two clock-pulse generators for the processor according to example embodiments of the present invention.

It may also be possible to provide in the processor according to the present invention exactly one clock-pulse generator for each execution unit respectively and one clock pulse generator for the device.

These two embodiments yield various advantageous options for synchronously or asynchronously controlling the execution units and the shadow registers.

In accordance with an example embodiment of the method according to the present invention, a switchover between a safety mode and a performance mode is performed, a method according to example embodiments of the present invention for correcting errors being executed in the safety mode and different programs or program segments or tasks being executed by the at least two execution units in the performance mode. A mode select signal is advantageously used to switch between the modes.

A control device according to example embodiments of the present invention for a motor vehicle has a device according to example embodiments of the present invention or a processor according to example embodiments of the present invention. With this, motor-vehicle control devices may be improved in terms of safety and performance.

Further advantages and refinements of example embodiments of the present invention are yielded from the description and the accompanying drawing.

It is understood that the aforementioned features and the features yet to be explained below may be used not only in the combination indicated in each instance, but also in other combinations or by themselves, without departing from the scope of the present invention.

Example embodiments of present invention are represented schematically in the drawing based on an exemplary embodiment and is described in detail below with reference to the drawing.

### BRIEF DESCRIPTION OF THE DRAWINGS

FIG. 1 shows a block diagram of a dual-core processor system that includes an example embodiment of the device according to the present invention;

FIG. 2 shows a schematic representation of the example embodiment of the device according to the present invention from FIG. 1;

FIG. 3 shows a schematic representation of the dual-core processor system from FIG. 1;

FIG. 4 shows a block diagram of a dual-core processor system for which an example embodiment of the device according to the present invention may be provided; and

FIG. 5 shows a section of a block diagram of an example embodiment of the device according to the present invention that may be provided in particular for a dual-core processor system according to FIG. 4.

### DETAILED DESCRIPTION

Identical elements are provided with the same reference numerals in all of the figures.

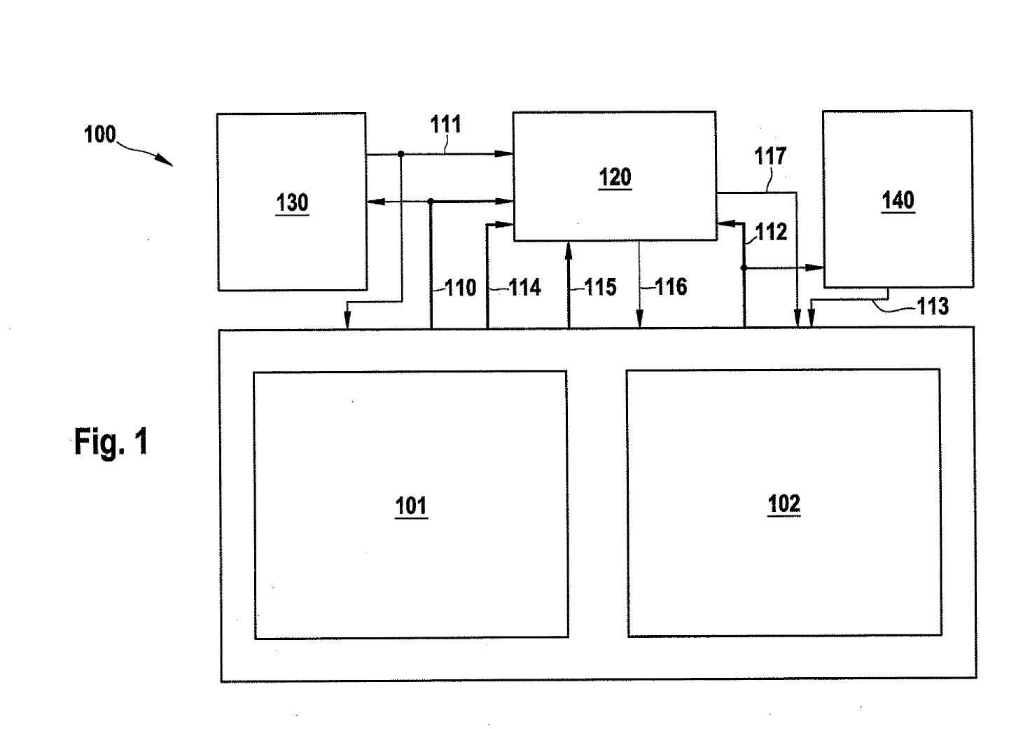

In FIG. 1, a dual-core or double-core processor system 100 is shown that features an embodiment of the device according to the present invention (recovery device) 120. Furthermore, the system features an instruction memory 130 and a data memory 140.

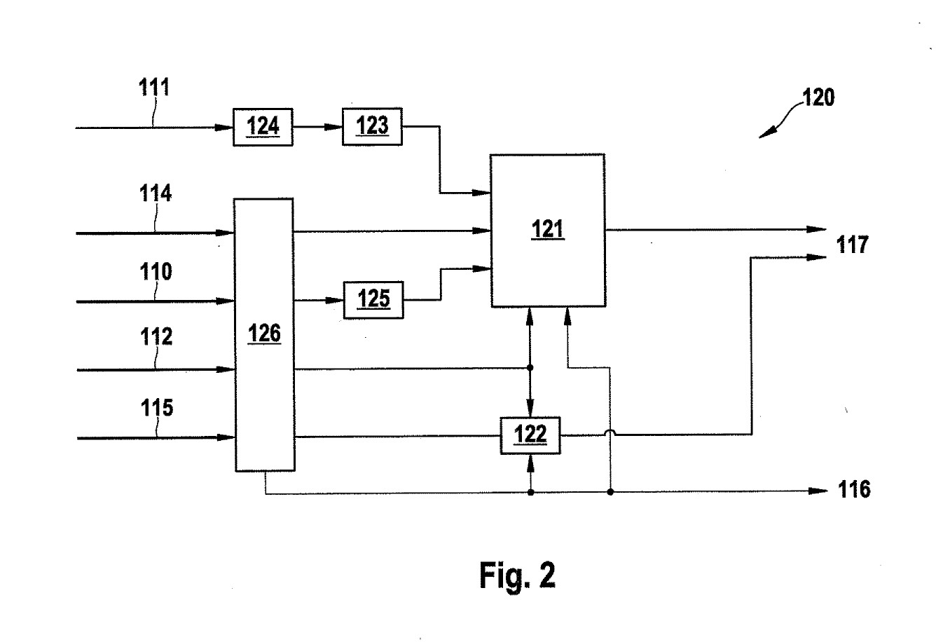

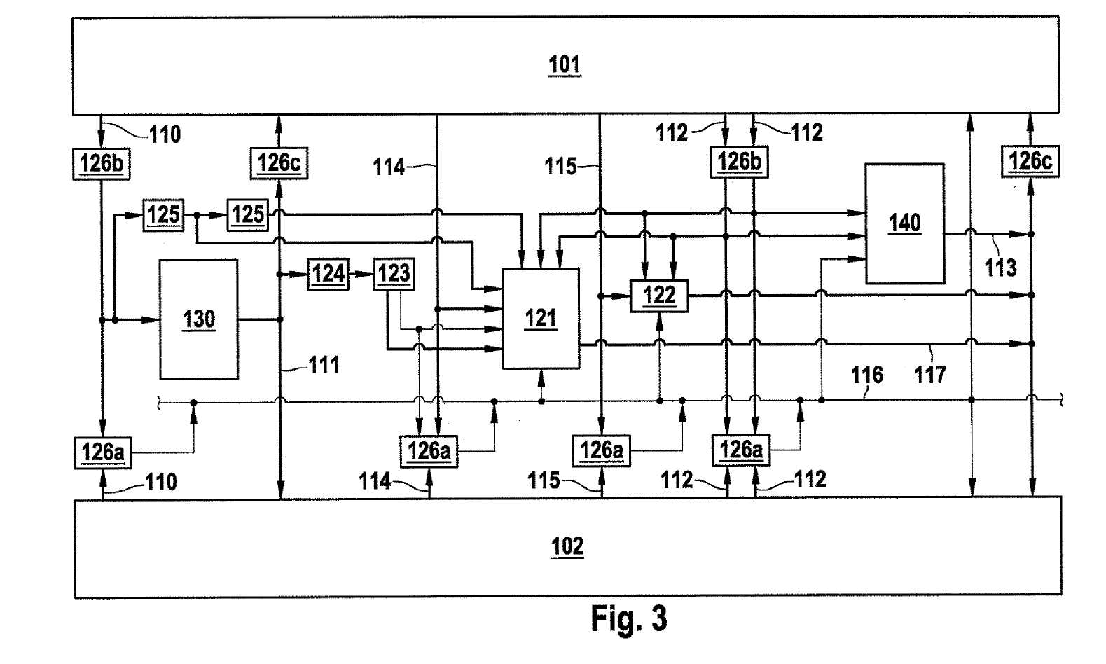

The dual-core processor system 100 has two execution units (CPUs, cores), one master 101, and one checker 102, that process one program in parallel. The output of data to the peripherals (application system) takes place only if the data from the master and the checker correspond. In this exemplary embodiment the recovery device is stored externally, that is, not integrated in the cores. Thus, particularly advantageously, except for conducting out particular internal signals, it is not necessary to modify the CPUs 101, 102. The inner structure of the recovery device is described more exactly in the FIGS. 2 and 3.

Instruction memory 130 of the system is designed as a fixed value memory, also referred to as read-only memory (ROM). The addresses for the instructions (instruction addresses) are carried to it via a connection 110. After applying an instruction address via connection 110, instruction memory 130 returns the corresponding instruction via a connection 111. The instruction is supplied to both CPUs 101 and 102. Instruction memory 130 is executed in the typical manner in the exemplary embodiment shown. Providing recovery device 120 does not change it. As shown in detail in FIG. 3, only the addresses of master 101 are carried to instruction memory 130, while the addresses of checker 102 are carried only to a comparator (comp) 126a that generates an error signal (error) if addresses or address parity of master and checker do not correspond. The parities are generated by parity generators 126b and checked by parity checkers 126c. These parity generators/checkers serve to safeguard the single-point-of failure path via the memories.

Data memory 140 of the system is designed as a read-write memory, also referred to as random-access memory (RAM). Addresses and data are supplied to it via a connection 112 (data address/data out). Furthermore, it outputs via a connection 113 corresponding data to the CPUs (data in). As can be seen more clearly in FIG. 3, these are the output lines of data addresses and data from master and checker. Here, the addresses and data for data memory 140 and for shadow register file 121 contained in recovery device 120 are output. Normally, the contents of the external data memory are transferred on data input lines 113 of master and checker. If comparator 126a detects a discrepancy (error) between the master and the checker, the secured contents of external register file 121 and of external PSW register 122 (FIG. 3) are transferred to master and checker on a corresponding line 117 after triggering the error signal (interrupt in). Inside the CPU, it is practical to connect or map the input of lines 113 and 117 to the write-back bus. Data memory 140 too is executed in the typical manner and is not changed by providing the recovery device. As can be seen in detail in FIG. 3, only the addresses and data of the master are carried to data memory 140, while the addresses and data of the checker are carried only to comparator 126a. This generates an error signal if addresses or data, or address parity or data parity of master and checker do not correspond. The parities are generated by parity generators 126b and checked by parity checkers 126c. These parity generators/checkers serve to safeguard the single-point-of-failure path via the memories.

The data and the instruction memory constitute weak points of the system, so-called single points of failure, since they each exist only one time in the system. For this reason, it is practical to safeguard the two memories, for example through ECC (error correcting codes) or other e.g., conventional, methods (secure memory).

The write-back bus, an internal bus, is carried via a line 114 to recovery device 110. On the write-back bus, different processor units such as ALU (arithmetical and logical unit) or data RAM write calculation results or data to the internal register file of the CPU.

Furthermore, the respective program status word or processor status word is output by master 101 and checker 102 via a line 115 (PSW out). The processor status word provides information about results of the execution of an instruction in the program run, for example, flags (relevant bits of the PSW) contain code that indicates whether the result of the computing operation is zero or negative (zero flag), or whether an overflow occurred (carry flag), etc. In addition, the PSW contains information about the interrupt status of the CPU. With knowledge of or the rewriting of the processor status word, a program may be correctly continued from the interrupted place.

A program interruption of the currently running program may be carried out via a line 116 (interrupt in), which is routed to master and checker. The interrupt line is preferably used to cause the two CPUs 101 and 102 to load the PSW and the register file data from external recovery module 120 and thus to replace their possibly false data with correct data. In the FIGS. 2 and 3, the source of line 116 corresponds to the signal error out, which is generated by comparator 126 or 126a (comp).

FIG. 2 shows a schematic representation of the internal structure of recovery device 120 from FIG. 1. For the sake of clarity, the clock-pulse offset between the two CPUs has been omitted in this block diagram. However, it is to be understood that a clock-pulse offset may also be provided. The recovery device has, as a shadow register, a register file 121 and a PSW register 122.

Register file 121 contains at least as many registers as master 101 or checker 102 or at least as many registers as are required to restore the application in question (essential registers). For writing, it is automatically addressed by an instruction decoder 123. For reading, it is addressed via line 112 (data address/data out) of the master. During operation, the data are written from the write-back bus via line 115 and in the case of error read from the data out outputs of the register file to the data in inputs of the CPUs via line 117. Alternatively, the data may also be written from the data out of the master. This is not necessary for the recovery device presented; however, it does not represent a significant hardware overhead and makes it possible to use the shadow register also in another form (for example, as an additional memory).

In order to be able to read out the shadow registers, they are preferably inserted in the memory address area. Then they may be accessed via simple write or read operations. In this specific embodiment, the execution units or CPUs 101, 102 access the shadow registers only in the event of an error and only by read access, since the write accesses are carried out by instruction decoder 123 that is provided in this example embodiment of the device according to the present invention.

If the comparison of the signals PSW out of the master and the checker does not indicate an error, the signal PSW out of master 101 is written to PSW register 122 via line 115. Alternatively, the signals data address/data out of the master may also address the PSW register, and the signal data out of the master may also be written to the PSW register. This procedure may be useful for possible expansions. The PSW is read out via PSW out and made available together with data out from register file 121 at line 117. This line is, as shown in FIG. 1, connected to data in from master and checker, access occurring again only in the event of an error.

Within recovery device 120, line 116 from a comparator/parity unit 126 is routed out of the recovery device, as shown in FIG. 1, and to register file 121 as well as PSW register 122 to ensure that no erroneous data is stored in the shadow register. As shown in FIG. 3, comparator/parity unit 126 is made up of at least one comparator 126a. It is advantageous to provide in addition at least one parity generator 126b and/or at least one parity checker 126c. If an error is detected in comparator/parity unit 126, the current data word (which was detected to be erroneous) may no longer be written to the shadow registers. However, since the triggering of an interrupt routine in the processor cores requires several clock cycles, the connection shown may prevent the writing if the shadow register is set up accordingly.

Comparator/parity unit 126 contains all compare and parity circuits to represent in particular the following functions:
Comparator of write-back bus from master and checker, the data being supplied via line 114. Since this bus is switched to “high-resistance” at times, which makes a comparison impossible, the write enable signal from the decoder must also be provided to this comparator.
Parity generator for the signal instruction address of the master as well as comparator for instruction address of master and checker, the data being supplied via line 110.
Parity generator for the signals data address and data out of the master as well as comparator for the signals data address and data out of master and checker, the data being supplied via line 112.
Comparator for the signal PSW out from master and checker, the data being supplied via line 115.

If an error is detected, an interrupt routine is started in the CPUs in the present example, through which routine the data from shadow register 121, 122 are transferred to the registers of the two CPUs 101, 102. If, for example, the PSW cannot be written in a CPU, the PSW or its bits may be set in the interrupt routine by an appropriate software routine. (For example, an addition with overflow may be carried out if the overflow flag must be set.) Afterwards, both CPUs 101, 102 may continue processing with correct register content.

In the example embodiment shown, device 120 according to the present invention also has instruction decoder 123 to detect the instructions that write to the register file. For these instructions, the instruction decoder generates the address for the registers of the register file that are to be addressed as well as the write signal. At the input, the decoder receives the instruction that is delayed by one clock pulse, and at the output, it outputs addresses and the write signal for register file 121. A unit 124 is provided for the clock-pulse delay by one clock pulse.

After the comparison, the signal instruction address is carried with a delay of two clock pulses to register file 121 by an additional clock-pulse delay unit 125. (As shown in more detail in FIG. 3, the instruction address is carried one more time additionally, also delayed by one clock pulse, to the register file, since in the case of an interrupt, the instruction address must be stored from a different pipeline stage than in the case of a jump. These are processor-specific details, however, that are not directly related to the recovery device.) In the event of a jump instruction, the register file stores the current instruction address. Within the processor, the instruction address is carried through the pipelines. It is also possible to obtain the jump address by conducting an additional bus out from the CPU; however, by the external continuation presented it is possible to minimize the intervention into the cores.

The signal error out is made available via line 116 at the input interrupt in of master and checker. Error out becomes active if comparator/parity unit 126 of recovery expansion 120 detects a deviation between master and checker.

FIG. 3 shows a schematic representation of the internal structure of the dual-core processor system from FIG. 1. For the sake of clarity, the clock-pulse offset between the two CPUs has also been omitted in this block diagram. In this figure, master 101 and checker 102 are illustrated separately, from which follows likewise the separate illustration of lines 110 to 117. Line 112 is implemented twice, which represents the two signals data address and data out.

The units of the recovery device, namely register file 121, PSW register 122, decoder 123, clock-pulse delay units 124, 125 and comparator/parity unit 126 as well as instruction memory 130 and data memory 140 are illustrated between the cores of the master and the checker. The subunits 126a, 126b, 126c of comparator/parity unit 126 are spatially separated in the illustration.

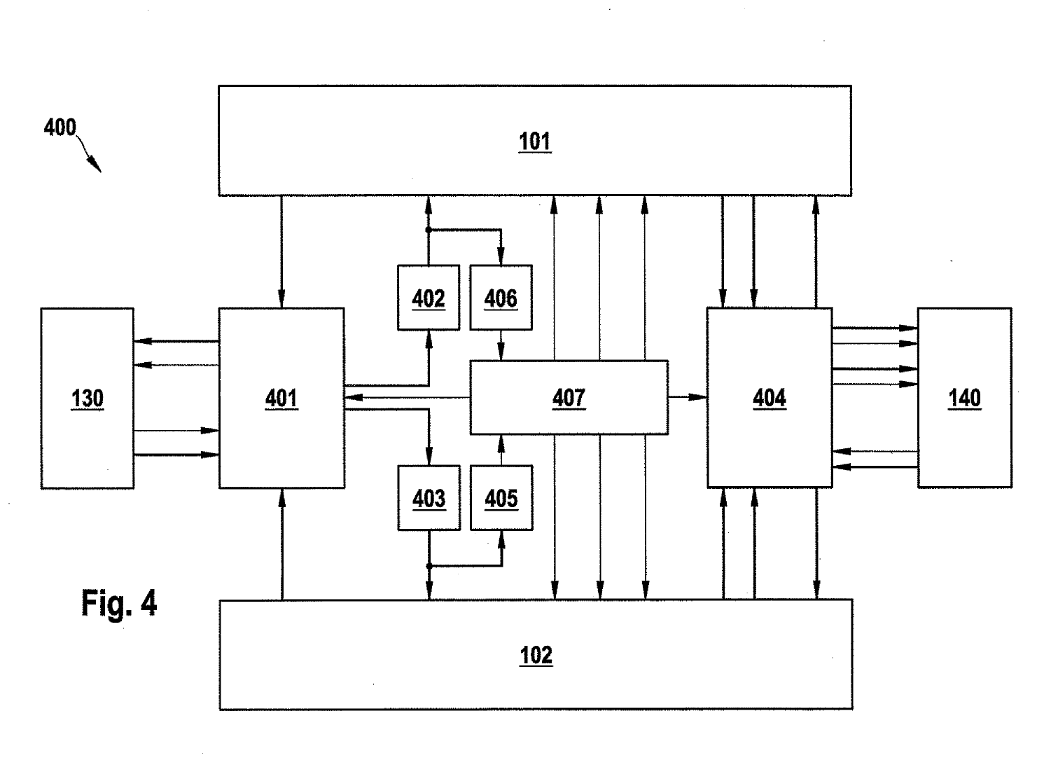

FIG. 4 shows a schematic representation of a dual-core processor system for which an example embodiment of the device according to the present invention may be provided. This block diagram shows a reconfigurable system in which it is possible to switch between a performance mode and a safety mode.

To ensure that the requirement for high computing performance or safety is met, it must be possible for the reconfigurable two-processor system to switch between the two modes in operation. In the safety mode, which is used when safety-related program code is processed, the system operates in the classic master/checker mode, an example embodiment of the device according to the present invention being used.

In the performance mode, the system operates like a two-processor system, featuring in particular the performance of a traditional two-processor system.

The operating system carries out the switchover between the two modes through a special instruction: the mode-switch instruction. This instruction is preferably detected outside of the processor by a unit that is external to the processor and transformed into a no operation instruction before it is relayed to the processor. Thus, intervention into the instruction decoder of the two processors is avoided.

In the safety mode, the system operates in accordance with the FIGS. 1 to 3, both cores processing the same program. Since some components exist only in one exemplar (for example, buses, timing circuit and supply voltage), these should be specially secured. To additionally secure the system against common cause errors like EMC or voltage spikes on the supply voltage, the two processors may operate with a clock-pulse offset in this mode.

In the performance mode, the CPUs process different programs or program segments or tasks and thus achieve a higher performance and computing power than a single CPU. Each CPU may trigger the instruction memory, the data memory, and the peripheral units. Thus, the clock cycle of these components and of the CPUs in the performance mode must be cophasal. If no clock changeover of a CPU occurs during the switchover from the safety mode to the performance mode, then this CPU would have to insert a wait clock-pulse in the performance mode during every access to the peripheral units until it receives the data. Since this involves a high loss in performance, for the performance mode the clock-pulse of this CPU is switched to the phase polarity of the master clock-pulse. To this end, the clock-pulse offset must be switched off in the performance mode.

Since both CPUs may now access the peripheral units, in this mode the accesses must be managed by special units (instruction-RAM control unit, data-RAM control unit). Since both CPUs now gain memory access to the instruction memory in every clock-pulse, these accesses must be uncoupled by one instruction cache per CPU so that the instruction memory does not become a performance-limiting factor. In the implementation shown, the cache controllers access the instruction memory with the aid of a burst access of four instructions. However, it is not necessary to also uncouple the data accesses by the two CPUs to the data memory through a cache since, for example, for automobile applications only every tenth instruction is a data memory access. If this distribution changes, a data cache may be provided for each CPU. In summary, this consequently is an expansion of a system that has a recovery functionality to include a performance functionality.

### Mode Switchover:

In the safety mode, both CPUs process the same instructions and perform identically. To this end, the internal states of the two CPUs, that is, the data in the registers and the instruction caches, must be identical. In the performance mode, however, the two CPUs process different instructions and thus the internal processor states are also different. Thus, the data in the two CPUs and in the instruction caches must be synchronized before a switchover from the performance to the safety mode.

An important prerequisite for the mode switchover of the switchable two-processor system is that the operating system may distinguish between the two similar CPUs. To this end, each CPU must have an assigned ID. For this purpose, a single bit is sufficient. In the safety mode, this bit must not be checked since otherwise the comparator would signal an error.

Furthermore, for a switchover between the two modes of the two-processor system, an instruction is necessary. By calling up the instruction, the mode change is started. The switchover from the performance mode to the safety mode is advantageously stored in the time tables for both CPUs. Usually, one CPU will begin the mode switchover first. This one starts the mode change and informs the second CPU simultaneously through an interrupt that this one too is to change modes.

Additionally, it should be ensured that in the performance mode each CPU has the option of executing at least two atomic accesses to the data memory. These non-interruptible memory accesses are necessary for the synchronization of the jointly used data of both processors or also for the task synchronization.

To ensure the data consistency in the performance mode, it is necessary for a CPU to have the option of reading out a value from the data memory and afterward of writing back this value in a modified form without an interruption by another CPU. This is in particular ensured by the fact that as soon as a particular memory area is accessed, data memory accesses for other CPUs are prevented by the creation of a wait command. The CPU may release the data memory again for other CPUs by an additional data memory access to the reserved address. The possibility of preventing other CPUs from accessing the memory allows for the implementation of techniques in software to allow data access to jointly used memories or the CPUs may, through “semaphore,” synchronize each other during the processing of tasks (not to be confused with the synchronization by which it is possible to change to the safety mode).

The switchover device(s) for switching between the modes are thus designed as mode-switch unit 407. The recovery device is intended to be used only in the safety mode. For this reason, it may be provided to route to the recovery device a core mode signal that is outputted by the mode switch unit. In conjunction with this, the recovery device may be designed such that the core mode signal is able to switch it on and off. In this context, it is likewise possible to provide that the recovery device be completely switched off in the performance mode, for example, through a clock enable signal, to reduce power consumption.

In FIG. 4 a dual-core processor system for which a preferred design of the device according to the present invention may be provided is labeled 400 in its entirety. The system has two CPUs, master 101 and checker 102, instruction memory 130 and data memory 140. The memories are not duplicated but rather are designed as secure memories, as described in more detail above. They may also be designed as duplicated.

An instruction-memory control unit (ICU) is labeled 401. The ICU manages all accesses of the two CPUs 101, 102 to the shared instruction memory 130. In the safety mode, only master 101 may request instructions from the instruction memory in the event of a cache miss. The ICU then reloads not only the one instruction but rather preferably executes a burst access to reload the cache line in one piece. In the process, an instruction cache 402 of master 101 receives the instructions directly, while an instruction cache 403 of checker 102 receives the instructions later after a provided clock-set offset.

Since in the performance mode both CPUs may request instructions simultaneously from instruction memory 130, ICU unit 401 must prioritize the accesses. Normally the master has the higher priority. However, to avoid thwarting the checker entirely in the worst case scenario, the checker has the higher priority if the master had access to instruction memory 130 in the previous clock cycle.

A data-memory control unit (DCU) is labeled 404. DCU 404 manages accesses of the two CPUs to data memory 140 and the peripheral units. Additionally, it must provide an individual processor identification bit. With the aid of this bit, the two CPUs may be distinguished by the operating system in the performance mode. This bit may be read out through a read access to a particular memory address. While the address for both CPUs is identical, the master receives, for example, a 0 while the checker receives a 1. If more than two CPUs are provided, correspondingly more bits must be used.

In the safety mode, all accesses to the data memory and the peripheral units are performed by the master while queries from the checker are used only for the comparison required for error detection. The data that have been read out are carried directly to the master and, with a possibly provided clock-pulse offset, for example, of 1.5 clock pulses, to the checker.

In the performance mode, DCU 404 must resolve the simultaneous accesses of the two CPUs to data memory 140 and to the peripheral units. In principle, the same prioritization occurs as did for ICU 401. Additionally, a semaphore mechanism is implemented to enable the data memory to be locked for the other CPU (similar to the MESI protocol): A CPU may lock the data memory so that it has exclusive access to it. During this time, the accesses of other CPUs are blocked by the DCU until the first CPU releases the memory again. The blocking and releasing takes place through a read access to a particular memory address (FBFF=64511 in this implementation), which access the DCU is able to detect. The prioritization is the same as it is for the data memory accesses. For a simultaneous lock request from both CPUs, the master receives the exclusive access rights first. The implementation of the memory lock mechanism takes place in the DCU so that standard processors can be used.

The functionality of the memory lock mechanism is made up of six states:
core1_access: Memory access by master. If the master wishes to lock the memory, it may do so in this state.
core2_access: Memory access by checker. If the checker wishes to lock the memory, it may do so in this state,
core1_locked: Master 1 has locked the data memory. It has exclusive access to the data memory and the peripheral units. If the checker wants to access the memory in this state, it is stopped by the wait2 signal until the master releases the data memory again.
core2_locked: Checker has reserved the data memory exclusively for itself. Now the master is stopped by the signal wait1 during data memory operations.
lock1_wait: The data memory was locked by the checker when the master also wanted to reserve it for itself. The master is therefore wait-listed for the next memory locking.

lock2_wait: Data memory was locked by the master. The checker is wait-listed for the memory.

Mode-switch detect units are labeled 405 and 406. The mode-switch detect units are respectively located between the instruction cache 402 or 403 and the CPU and monitor the instruction bus. As soon as they notice the mode-switch instruction, they inform a mode switch unit 407 of this. This functionality could also be implemented through the instruction decoder of the two processors. Since here, however, standard processors are to be used without an internal modification, this is implemented externally. A disadvantage of this is that the instruction is detected as soon as it is read out of the memory. Now, if there is a Jump instruction in the previous program run, the switchover instruction is still active, even though it actually would be deleted in the pipeline because of the jump. Thus, the system would change modes erroneously. However, this problem may be solved if the instructions are rearranged by the compiler in such a way that there is no jump instruction in front of the mode-switch instruction. The necessary distance between the jump instruction and the mode-switch instruction depends on the number of pipeline stages of the CPUs used.

As already mentioned, the mode switchover is implemented by the software. The hardware support necessary for this is implemented in mode-switch unit 407. The following program excerpt represents, for example, the switchover from the safety to the performance mode:

| LDL | r1, 248 | |
|---|---|---|
| LDH | r1, 255 | (1) |
| MODE-SWITCH | | (2) |
| LDW | r2, r1 | (3) |
| BTEST | r2, 5 | (4) |
| JMPI_CT | | (5) |

In row (1) the address at which address the DCU outputs the processor ID bit is loaded to register r1. Next (2), the mode-switch instruction is performed. Since both processors work in the safety mode with a clock-pulse offset of 1.5 clock pulses in this example, the mode-switch detect unit of the master detects the switchover instruction first. It communicates this through the signal core1_signal of the mode-switch unit, which consequently stops the checker through the signal wait1. 1.5 clock-pulses later, the mode-switch detect unit of the checker likewise detects the switchover instruction. Afterward, the mode-switch unit stops the checker for a half clock-pulse to synchronize the clock-pulse signals of the two CPUs with reference to the phase. In the end, the mode signal is switched from the safety mode to the performance mode and the wait signals are taken away. The two CPUs now continue working with identical clock-pulse signals. In step (3), the two CPUs now load their processor identification bit from the DCU. Then (4) a check is performed to see whether the bit is set to 0 or 1 and a contingent jump is executed by the checker (5) since its core ID bit is 1. The master does not execute a jump but rather continues working at this program position since its core ID bit is 0. Thus, the program run of the two CPUs is—as requested—separated. During the switchover from the performance to the safety mode, first the recovery device is activated via the core mode signal. Afterward, the cache is emptied (flushed) in order to prevent remaining data from being taken over into the recovery device. Then the register contents of the two processors are adjusted via a software routine that at the same time also writes to the shadow registers in the recovery device. For this reason, no software adjustments are necessary for the recovery device other than the cache flush. By incorporating register stages between the individual processors as well as in front of particular input signals, it is possible to operate the processors in clock-pulse offset, which serves to limit common-mode errors.

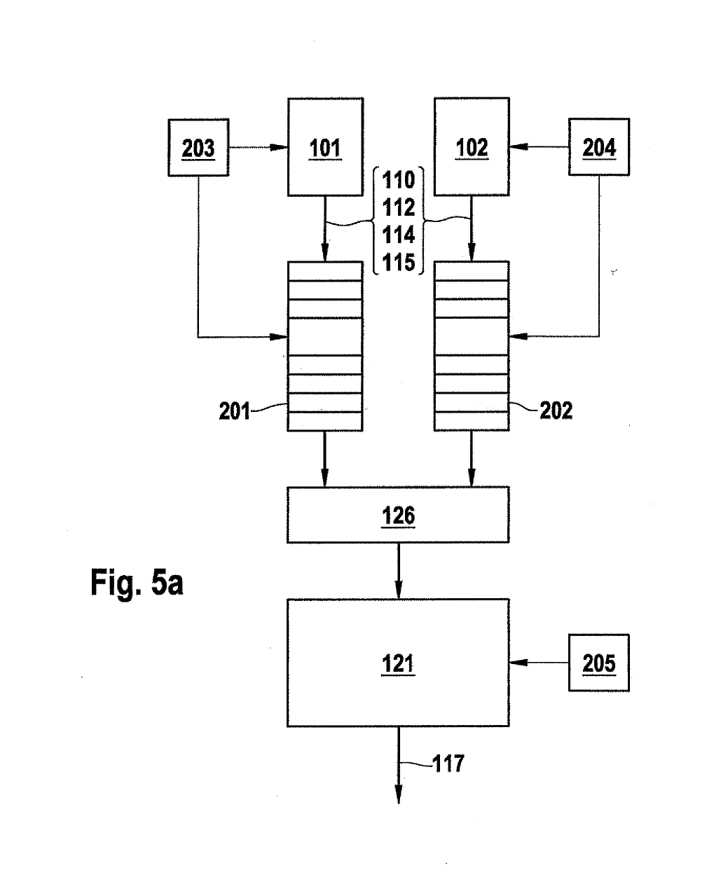

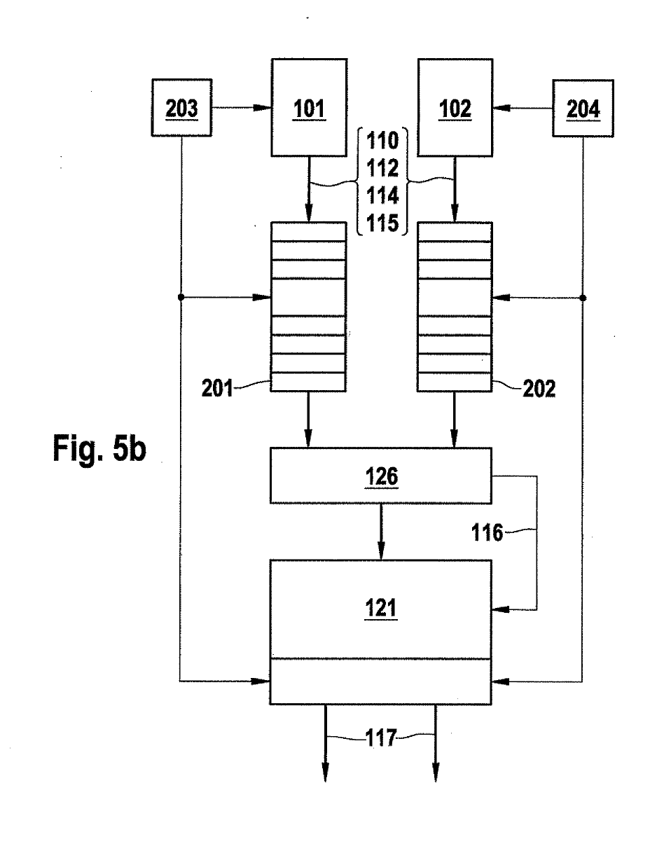

Additionally, multiple clock generators (clock) (quartzes) may be used for the individual processors, as described with the aid of FIG. 5. Together, FIG. 5a and FIG. 5b are labeled FIG. 5. FIG. 5a shows an example for three clock generators; FIG. 5b shows an example for two clock generators. For the sake of clarity, FIG. 5 shows only the structure relating to register file 121. The structure relating to the PSW register does not differ from this.

Master 101 and checker 102 provide data, as described, to recovery device 120 via lines 110, 112, 114 and 115. In the design according to FIG. 5, separate clock generators 203 and 204 are provided for master 101 and checker 102. It is also possible for these clock generators to be designed as integrated in the cores. Where that is the case, the clock generator signal (clk) must be conducted out. The two processors now no longer work synchronously. For this reason, when writing to the recovery device, it should be ensured that the two CPUs do not run too far apart (that is, the clocks pulse offset must not get too large). To this end, FIFO buffer stages 201, 202 (First In First Out) that buffer the incoming signals and that are driven by the core clock generators 203, 204 are inserted in front of the comparator/parity unit 126. As soon as the CPUs 101, 102 run too far apart, the faster one maybe stopped, for example, by a wait signal until they run synchronously again.

In the design according to FIG. 5a, shadow register file 121 as well as PSW register 122 (not shown) are clocked by a separate clock generator 205 (not shown).

In the design according to FIG. 5b, shadow register file 121 as well as PSW register 122 (not shown) are clocked by core clock generators 203, 204. In this case the register file must be written asynchronously. In this context, the write process is controlled via comparator/parity unit 126 that dispatches a write signal every time that two new corresponding data words are applied. If the data words do not correspond, the comparator/parity unit generates an error signal via line 116. In this case, the read access to shadow register file 121 also occurs synchronously via clock generators 203, 204 of the individual cores 101, 102.

It is to be understood that the example embodiments explained above of the method according to the present invention are to be understood only as examples. In addition to them, one skilled in the art would understand additional design approaches without leaving the framework of the present invention.

1-21. (canceled)

22. A device for correcting errors in a system having at least two execution units having registers, the registers configured to record data, comprising:
a comparison device arranged such that through a comparison of data that are provided for storage in the registers a deviation and, with the aid of the deviation, an error is detectable;
at least one shadow register arranged such that data concerning data of the registers are storable therein; and
a device configured to restore error-free data in at least one register on the basis of the data in the at least one shadow register in the event that an error is detected.

23. The device according to claim 22, wherein at least one of (a) a processor status word, (b) a register file, and (c) a shadow register records an instruction address.

24. The device according to claim 22, wherein the at least one shadow register is insertable in a memory area of at least one execution unit.

25. The device according to claim 22, further comprising an instruction execution unit configured to execute instructions from an instruction memory of the system having at least two execution units having registers for obtaining address and write signals for the at least one shadow register.

26. The device according to claim 22, wherein the data concerning the data of the registers are the data of the registers themselves, and the device configured to restore error-free data in at least one register on the basis of data in the at least one shadow register in the event of an ascertained error is configured to transfer the data from the at least one shadow register to at least one register.

27. The device according to claim 22, wherein the data concerning the data of the registers are check sums.

28. A processor, comprising:
at least two execution units having registers, the registers configured to record data; and
a device configured to correct errors in a system having the at least two execution units, the device including:
a comparison device arranged such that through a comparison of data that are provided for storage in the registers a deviation and, with the aid of the deviation, an error is detectable;
at least one shadow register arranged such that data concerning data of the registers are storable therein; and
a device configured to restore error-free data in at least one register on the basis of the data in the at least one shadow register in the event that an error is detected.

29. The processor according to claim 28, further comprising a switchover device configured to switch over between a safety mode and a performance mode, the at least two execution units executing the same program in the safety mode and executing different programs in the performance mode.

30. The processor according to claim 28, further comprising a device configured to empty a cache memory.

31. The processor according to claim 28, wherein at least two clock generators are provided.

32. The processor according to claim 31, wherein exactly one clock generator is provided for one execution unit respectively, and one clock generator is provided for the device.

33. A method for correcting errors in a system having at least two execution units having registers, comprising:
providing data for storage in the registers;
comparing the data;
detecting an error in the event of a deviation; and
restoring error-free data in at least one register on the basis of data in at least one shadow register in the event that an error is ascertained, the at least one shadow register configured to record data concerning the data of the registers.

34. The method according to claim 33, wherein at least one of (a) a processor status word, (b) a register file, and (c) an instruction address is stored in the at least one shadow register.

35. The method according to claim 33, wherein the at least one shadow register is inserted in a memory area of at least one execution unit.

36. The method according to claim 33, wherein instructions from an instruction memory of the system having at least two execution units having registers are executed, address and write signals for the at least one shadow register being obtained.

37. The method according to claim 33, wherein the at least one shadow register is assigned a parity for ascertaining the correctness of the data in the shadow register.

38. The method according to claim 33, wherein the data concerning the data of the registers are the data of the registers themselves and error-free data in at least one register are restored through transfer of the data from the at least one shadow register to the at least one register.

39. The method according to claim 33, wherein the data concerning the data of the registers are check sums.

40. The method according to claim 33, wherein the data of at least two registers and at least one shadow register are compared and the data that agree for the most part are determined to be error-free.

41. The method according to claim 33, wherein a switch is performed between a safety mode and a performance mode, the at least two execution units executing different programs in the performance mode.

42. A control device for a motor vehicle, comprising:
one of
(a) a device for correcting errors in a system having at least two execution units having registers, the registers configured to record data, including:
a comparison device arranged such that through a comparison of data that are provided for storage in the registers a deviation and, with the aid of the deviation, an error is detectable;
at least one shadow register arranged such that data concerning data of the registers are storable therein; and
a device configured to restore error-free data in at least one register on the basis of the data in the at least one shadow register in the event that an error is detected; and
(b) a processor, including:
at least two execution units having registers, the registers configured to record data; and
a device configured to correct errors in a system having the at least two execution units, the device including:
a comparison device arranged such that through a comparison of data that are provided for storage in the registers a deviation and, with the aid of the deviation, an error is detectable;
at least one shadow register arranged such that data concerning data of the registers are storable therein; and
a device configured to restore error-free data in at least one register on the basis of the data in the at least one shadow register in the event that an error is detected.
